(19) United States
(12) Patent Application Publication
(10) Pub. No.: US 2010/0092867 A1
(43) Pub. Date: Apr. 15, 2010

(54) Porous Polymer Electrodes

(75) Inventors: Aldrich N.K. Lau, Palo Alto, CA (US); Konrad Faulstich, Salem-Neufrach (DE); Kristian M. Scaboo, Castro Valley, CA (US)

Correspondence Address: LIFE TECHNOLOGIES CORPORATION;C/O INTELLEVATE, P.O. BOX 52050, MINNEAPOLIS, MN, 55402, US

(73) Assignee: Applied Biosystems, LLC, Carlsbad, CA (US)

(21) Appl. No.: 12/504,488

(22) Filed: Jul. 16, 2009

Related U.S. Application Data
(63) Continuation of application No. 11/479,175, filed on Jun. 30, 2006, now abandoned.
(60) Provisional application No. 60/695,910, filed on Jun. 30, 2005.

(51) Int. Cl. H01M 4/58; H01M 4/02

(52) U.S. Cl. 429/231.8; 429/209

(57) ABSTRACT

Porous polymer electrode assemblies are useful in the detection or quantification of a variety of analytes. By preparing a porous monolith, and applying a conductive polymer to the monolith, a porous matrix is prepared that combines favorable conductive properties, by virtue of the presence of the conductive polymer, with the porous character of the underlying monolith. The resulting porous electrode can be used for qualitative or quantitative analysis, and the capture and/or release of selected charged materials, such as nucleic acids. The pores of the electrode matrix may also be filled with nonconductive material, yielding electrodes having a plurality of discrete conductive surfaces.

### CROSS-REFERENCE TO RELATED APPLICATIONS

This application is a continuation of U.S. application Ser. No. 11/479,175, filed Jun. 30, 2006, which claims a priority benefit under 35 U.S.C. §119 of U.S. Provisional Patent Application No. 60/695,910, filed Jun. 30, 2005, which are hereby incorporated by reference.

### SUMMARY

Conductive polymer electrodes are useful in the detection or quantification of a variety of analytes. By preparing a porous monolith, and applying a conductive polymer to the monolith, a porous matrix is prepared that combines favorable conductive properties, by virtue of the presence of the conductive polymer, with the porous character of the underlying monolith. The resulting porous electrode can be used for qualitative or quantitative analysis, and to capture and/or release charged materials, such as nucleic acids. The pores of the electrode matrix may also be filled with nonconductive material, yielding electrodes having a plurality of discrete conductive surfaces.

### BRIEF DESCRIPTION OF THE DRAWINGS

FIG. 1 is a cross-sectional view of a selected porous polymer electrode assembly.

FIG. 2 is a partial cross-sectional view of an alternative porous polymer electrode assembly.

FIG. 3 is a perspective view of the face of another alternative electrode assembly.

FIG. 4 is a partial cross-sectional view of yet another alternative electrode assembly.

FIG. 5 is a cross-sectional view of yet another alternative electrode assembly.

FIG. 6 is a perspective view of yet another alternative electrode assembly.

FIG. 7 is a plot showing the electropolymerization of methoxythiophene, as described in Example 1.

FIG. 8 is a plot showing cyclic voltammetry changing the charge state of a conductive polymer coating, as described in Example 1.

FIG. 9 schematically depicts the preparation of a porous polymer film, as described in Example 3.

FIG. 10 schematically depicts the preparation of a porous polymer monolith inside a glass capillary tube, as described in Example 4.

FIG. 11 is a scanning electron microgram of a porous polymer monolith prepared according to an embodiment of the present invention.

FIG. 12 is a cyclic voltammogram of poly(3-butylthiophene-2,5-diyl) coated on a vitreous carbon disk electrode, as described in Example 5.

FIG. 13 is a microgram of a reticulated vitreous carbon electrode coated with poly(3-butylthiophene-2,5-diyl), as described in Example 6.

FIG. 14 is a cyclic voltammogram of a reticulated vitreous carbon electrode coated with poly(3-butylthiophene-2,5-diyl), as described in Example 6.

### DESCRIPTION OF SELECTED EMBODIMENTS

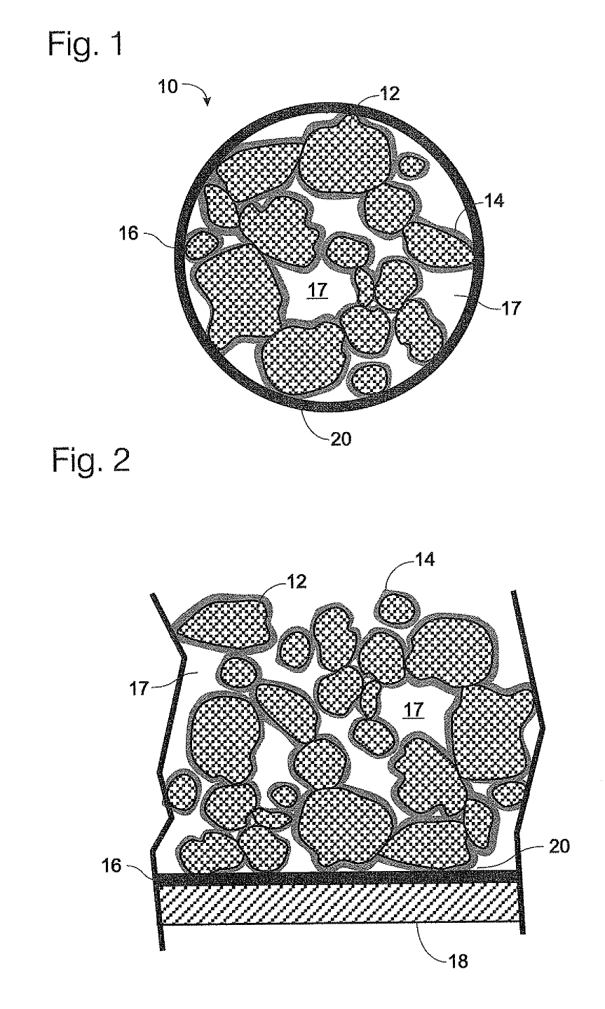

FIG. 1 depicts an exemplary porous conductive polymer electrode assembly 10, as seen in cross-section. The particular electrode assembly of FIG. 1 is cylindrical, although a variety of geometries are suitable for the disclosed electrode assemblies. The electrode assembly includes a porous monolith 12 that provides a matrix for the resulting electrode. Applied to the surface of the porous monolith is a conductive polymer 14.

Conductive polymer 14 is typically in electrical contact with a source of electrical potential. In one aspect, the electrical contact is provided by a conductive layer 16 that is in electrical contact with polymer 14. Conductive layer 16 of electrode assembly 10 encircles the cylindrical electrode assembly itself. The electrical contact may be direct, where conductive layer 16 physically contacts at least a portion of polymer 14, or indirect, such as where porous monolith 12 is itself suitably electrically conductive. Any suitably robust and conductive material can be used to provide an electrical connection between the conductive polymer 14 and a source of electrical potential. Conductive layer 16 is typically a highly conductive metal, such as for example, gold, platinum, aluminum, nickel, or chromium. In a particular aspect of the electrode assembly, the conductive layer includes gold metal. In an alternative aspect, the conductive layer includes platinum.

The electrode assemblies may be fabricated in any of a variety of geometries. Typically, the electrode assembly is microscopically porous. That is, the assembly incorporates a matrix having pores, cavities, or channels 17, typically having a diameter of about 2 μm to about 100 μm, where at least some of the matrix surfaces are conductive and capable of being charged. The pores, cavities, or channels present in the porous matrix may be manually formed, or may present as a byproduct of the formation of porous monolith 12. These pores 17 may have a regular or irregular shape, and may be arranged regularly, such as in an array, or in no particular short- or long-range order. Typically, where the electrode assembly is porous, the microchannels, which may trace a tortuous path, permit the flow of a fluid through the matrix, so that the fluid is in at least intermittent contact with areas of conductive polymer. The particular porosity of the electrode assembly is dependent upon, and may be tailored by the particular method of preparation used. In one aspect, the porous character of the electrode assembly occurs by virtue of the conductive polymer being applied to a porous monolith 12 having the desired porosity.

While the conductive polymer used to coat the porous monolith may exhibit an intrinsic porosity, the pore sizes are typically quite small. This ‘microporosity’ can include pores having radii ranging from 1-100 or 1-1000 nm. This microporosity is distinct from the porous topography, or ‘macroporosity’ present in the porous monolith, and therefore reflected in the porous polymer electrode. This macroporosity may include pores having diameters of about 2 μm to about 100 μm. Alternatively, the pores of the porous polymer electrode are selected to have a size appropriate for and complementary to a particular analyte molecule.

Although the components of the electrode assembly may be selected and fabricated so that they possess sufficient strength and integrity for practical use, the durability of the resulting electrode may be improved by the presence of a substrate layer 18, as shown for the planar electrode assembly of FIG. 2. Although the substrate may participate in conducting electrical potential to the conductive layer 16 and/or porous monolith 12, typically the substrate provides mechanical integrity to the electrode assembly, and optionally provides a base or foundation for fabrication of the electrode assembly.

Substrate 18 can be formed from a variety of materials. Typically, the substrate is manufactured from a material that is substantially chemically inert, and readily shaped and/or machined. The substrate can include, for example, metal, glass, silicon, or other natural or synthetic polymers. The substrate can be formed into any of a variety of configurations. More particularly, the substrate can be shaped and sized appropriate so that the resulting electrode assembly can be used in conjunction with analytical systems employing capillary channels, microwells, flow cells, or microchannels.

Where a substrate is present, conductive layer 16 is typically deposited on the surface of the substrate so as to form any necessary electrical circuitry, including an electrical connection to a potential source. Application of the conductive layer can be via, for example, electroless plating, electroplating, vapor deposition, spluttering, or any other suitable method of applying a conductive material.

In order to facilitate a strong interaction between conductive layer 16 and porous monolith 12 or conductive polymer 14, conductive layer 16 may be physically or chemically modified to enhance the interaction with the polymer. For example, where conductive layer 16 is a metallic layer, the metal surface can be chemically activated, or physically roughened, or both. In particular, where the conductive layer is a gold metal layer, chemical activation of the gold surface with a thiol compound can be advantageous in attaching subsequent polymer layers. In one aspect, the gold surface can be modified with α-mercapto-PEG-ω-aldehyde that is subsequently treated with 3-minopropyl methacrylate, resulting in an active surface moiety that can undergo copolymerization during the application of a polymeric porous monolith 12. A variety of sulfur-containing compounds and their derivatives (e.g. thiols or disulfides) can be used to modify the gold conductive surface.

As discussed above, electrode assembly 10 can include a conductive surface polymer 14 that has been applied to an underlying porous monolith 12. Electrode assembly 10 can be prepared by preparing a porous monolith on conductive layer 16 in such a fashion that the applied porous monolith incorporates the desired topography, i.e. cavities, pores and/or irregularities having the desired size, shape, and arrangement. The porous monolith can then be modified throughout its porous structure via application of the desired conductive polymer 14. The porous monolith may be prepared from conductive or nonconductive material, provided that an electrical connection is provided between the conductive polymer 14 and the conductive layer 16. Where the porous monolith 12 is substantially nonconductive, the porous monolith can be applied so that portions of the conductive layer are exposed, and therefore placed in electrical communication with the conductive polymer 12, as shown at 20 in FIG. 1. Where porous monolith 12 is itself conductive, the porous monolith can serve as a direct electrical connection itself, obviating the need for a conductive layer. Typically, conductive layer 16 provides a good electrical connection between conductive polymer 14 and a source of applied electrical potential.

A particularly advantageous porous monolith can be prepared from a three-dimensionally porous film of a poly(acrylic acid), or copolymers of a poly(acrylic acid), which can be polymerized in situ and covalently bound to the surface of conductive layer 16.

The porous polymer monolith film can be prepared by free radical polymerization of selected monomer subunits. Uni-molecular photoinitiators and/or bi-molecular photoinitiators can be used to initiate the polymerization reaction. It can be desirable to utilize a combination of uni-molecular and bimolecular polymerization initiators, as such systems can enable free radical polymerization of vinyl and ethenyl monomers even in the presence of oxygen.

For example, a suitable porous polymer monolith can be prepared by polymerization of a mixture of acrylic acid and methylenebisacrylamide can be carried out using a combination of a unimolecular and bimolecular initiators. Suitable unimolecular initiators include, but are not limited to, benzoin esters, benzil ketals; alpha-dialkoxy acetophenones, alpha-hydroxy-alkylphenones, alpha-amino alkyl-phosphines, and acylphosphine oxides. Suitable bimolecular initiators typically require a coinitiator, such as an amine, to generate free radicals. Bimolecular initiators include, but are not limited to benzophenones, thioxanthones, and titanocenes.

In one aspect the porous polymer monolith is prepared using phase separation/precipitation techniques in order to create the desired monolith porosity, and therefore the porosity and/or topography of the resulting electrode surface. Porous poly(acrylic acid) monolith can be precipitated by free radical polymerization in the presence of a porogen (an organic solvent), for example dioxane, heptane, pentadecane, ethyl ether, and methyl ethyl ketone. A thin film of a solution including acrylic acid, methylenebisacrylamide, and uni-/bimolecular photoinitiators in methyl ethyl ketone (MEK) can be photopolymerized using a UV-light source. At the early stage of the polymerization process, a transparent gel is obtained. As the polymerization proceeds to high conversion, the crosslinked polymer is no longer soluble in MEK and precipitates (leading to phase separation) and forms a porous film. Polymerization and subsequent phase separation can be used to form a polymer monolith having the desired degree of porosity. The porous polymer films obtained by in situ polymerization typically exhibit superior surface topology, and generally have fewer defects. The porosity and pore size of the resulting polymer monolith can be tailored by the selection of the porogen (solvent), the particular monomer(s), and the polymerization parameters utilized. The mechanical properties of the porous polymer monolith can also be tailored by the addition of an appropriate crosslinking agent and/or selection of desired co-monomer.

Typically, the mechanical integrity of the porous monolith is enhanced when the porous polymer film is bonded to the substrate covalently. For example, where the substrate is glass, the glass surface can be modified using a reactive silane reagent. For example, by reacting the silanol groups on the glass surface with (3-methacryloxypropyl)methyldimethoxysilane, a polymerizable methacryloxy-group is formed that can undergo copolymerization with acrylic acid, covalently bonding the porous polymer monolith to the glass substrate.

In another aspect, a suitable porous polymer monolith can be prepared by sintering polymeric microparticles. Suitable microparticles may be commercially available, or they can be prepared beforehand. For example, where the microparticles include crosslinked poly(acrylamide), suitable microparticles can be synthesized via inverse emulsion polymerization of acrylamide. The polymerization process can be initiated by a thermal initiator, for example, potassium persulfate. Polymerization can further occur in the presence of a suitable polymerization catalyst, for example tetramethylethylenediamine, among others. Polymerization may also be performed in the presence of a desired crosslinking agent, for example N,N-methylenebisacrylamide, among others. The crosslinked poly(acrylamide) microparticles can be purified, for example by dialysis, and collected by precipitation from a suitable organic solvent

To prepare the desired porous monolith, a composition that includes the polymeric microparticles can be coated onto the surface of the desired substrate. Typically, the polymer microparticles are prepared with a sufficient degree of crosslinking that the microparticles sinter, or become a coherent solid, at elevated temperatures to give a porous monolith having the desired porosity. In order to achieve the desired monolith character, the microparticle formulation can contain a thickening agent to control monolith thickness. The thickening agent can be, for example, a silica thixotropic agent, or a water-soluble polymer such as non-crosslinked poly(vinyl alcohol) or PAA.

Any suitable process can be employed for applying the microparticle composition and sintering the microparticles. For example, the microparticle composition can be applied by spin casting, dip coating, spray coating, roller coating, or other application methods. The resulting coating is typically dried with application of external pressure at elevated temperature. For example, a pneumatic hot press can be used to sinter the microparticles to form the porous monolith. After the sintering process, any water-soluble thickening agent present can be removed by rinsing the porous monolith with water.

A primer can be used to improve the adhesion of the sintered monolith onto the desired substrate. For example, where the substrate is glass, the primer can be a silane-derivatized surface agent. The primer can also be a layer of non-crosslinked poly(acrylic acid), polymerized in situ and covalently bonded onto the substrate surface as described above.

Typically, where it is advantageous for the porous polymer electrode to exhibit a more open pore structure, for example in applications where a sample solution flows through the electrode assembly, the more open pore structure resulting from the phase separation/precipitation method of monolith preparation can be preferable.

The polymeric porous monolith formulations described above offer hydrolytic stability, a high degree of control over the surface characteristics of the porous monolith, and cost-effectiveness. However, a variety of other porous monolith compositions may also be used to prepare a monolith having the desired degree of porosity, and that are suitable for application of an appropriately porous electrode assembly.

For example, the porous monolith may be formed from carbon. Specifically, the porous monolith can be formed from carbon cloth, carbon mat, reticulated vitreous carbon, carbon felt, or other carbon materials. A conductive adhesive can be used to bond the carbon porous monolith onto the conductive layer. Any appropriate conductive adhesive can be used, including for example a paste comprising a carbon black powder dispersed in a thick solution of polyvinylidene fluoride (PVDF) in N-methylpyrrolidinone. The conductive layer can include, for example, metallic stainless steel or gold. The conductive surface polymer can then be applied to the porous monolith to form the desired electrode assembly.

The application of the conductive polymer 14 can be facilitated by selecting a porous monolith composition having a surface that will interact with the applied coating. For example, the porous monolith can include appropriate functional groups, such as carboxylic acid groups, among others, so that the applied conductive polymer can interact ionically and/or covalently with the porous monolith to enhance binding.

The conductive polymer can be applied to the porous monolith utilizing chemical oxidation. For example, ferric chloride can be used as an oxidant for the precursors pyrrole and bithiophene, and where the porous polymer monolith exhibits surface carboxylic acid groups, treatment of the porous monolith with ferric chloride typically results in association of the Fe(III) ions with the carboxylate groups. When the resulting ferric-loaded porous polymer monolith is exposed to a solution of an appropriate monomer, such as pyrrole or bithiophene, an oxidized and conductive polymer can be deposited on the porous monolith surface. It should be appreciated that any of a variety of analogous chemical oxidants may be used in this manner. For example, where the porous monolith surface is functionalized with ammonium moieties, sodium persulfate can be bound to the surface via the ammonium groups, and subsequently used to oxidize an applied polymer precursor.

Alternatively, the conductive polymer layer can be prepared electrochemically, either in the absence or in the presence of a chemical oxidant. In particular, where the pores present in the porous polymer monolith expose an underlying conductive layer, the conductive polymer can be grown from the surface of the conductive layer itself, creating an advantageous electrical connection between the conductive layer 16 and the conductive polymer 14. Various counter anions (dopants) can be used in this approach, and “doping-dedoping-redoping” techniques as described by Li et al. (Synthetic Metals, 92, 121-126 (1998)) can be employed to in order to improve conductivity of the resulting conductive polymer.

The conductive polymer layer can be prepared via the chemical and/or electrochemical oxidation of any appropriate monomer or combination of monomers. As used here, an appropriate monomer is one that, upon oxidation, produces a polymer that exhibits sufficient conductivity to be useful as an electrode surface layer. Typically, the resulting polymer can be oxidized and reduced in a controllable and reversible manner, permitting control of the surface charge exhibited by the polymer. Appropriate monomers include, but are not limited to, acetylene, aniline, carbazole, ferrocenylene vinylene, indole, isothianaphthene, phenylene, phenylene vinylene, phenylene sulfide, phthalocyanines, pyrrole, quinoxaline, selenophene, sulfur nitride, thiazoles, thionaphthene, thiophene, and vinylcarbazole, including their derivatives, and combinations and subcombinations thereof.

In one aspect, the conductive polymer can be prepared via chemical and/or electrochemical oxidation of a substituted thiophene, typically an alkyl-substituted thiophene. The substituted thiophene used to prepare the conductive polymer can include 3-methylthiophene, 3-ethylthiophene, 3-propylthiophene, 3-butylthiophene, 3-pentylthiophene, 3-hexylthiophene, 3-cyclohexylthiophene, 3-cyclohexyl-4-methylthiophene, 3-phenylthiophene, 3-octylthiophene, 3-decylthiophene, 3-dodecylthiophene, 3-methoxythiophene, 3-(2-methoxyethoxy)ethoxymethylthiophene, 3,4-ethylenedioxythiophene, 2,2′:5′,2″-terthiophene, 2,2′,5′,2″,5″,2′″ quaterthiophene, α-sexithiophene, among other, or a combination thereof. Alternatively, or in addition, the conductive polymer can be a copolymer of thiophene and other derivatives, for example poly(3,4-ethylenedioxythiophene)-block-poly(ethylene oxide).

In a particular example, a non-conductive polyaniline is synthesized according to the protocol reported by Chiang and MacDiamid (Synthetic Metals, 13, 193-205 (1986)). The non-conductive polyaniline, which is soluble in N-methylpyrrolidinone (NMP), can be applied to the porous monolith. The coated polyaniline can then be oxidized either electrochemically or chemically to create the conductive polymer layer. The ionic interaction between the conductive polyaniline and the negatively charged porous polymer monolith, as well as physical interlocking, anchors the conductive polymer to the porous monolith surface. Where the porous monolith is functionalized with carboxylic acid groups, these can serve as the counter anion of the conductive polymer. The positive charges on the outer surface of the conductive polymer surface can then be used to attract and/or immobilize negatively-charged analytes, and subsequently neutralized electrochemically, to release the captured analytes.

The porous polymer electrodes described herein typically offer a large electrode surface area. This enhanced surface area can offer advantages in selected applications, as will be discussed below. However, the surface area can also result in the electrode exhibiting a significant background double layer capacitance. Where this background signal is undesirable, it can be attenuated by modifying the surface of the porous electrode so that the electrode includes a plurality of discrete conductive domains, where the domain can be partially or fully isolated by a nonconductive matrix. Such a configuration can isolate the conductive domains, thereby reducing the geometric area while still allowing for overlap of the diffusion zones of the respective conductive domains. This can reduce the charging current while still allowing for maximum sampling of the solution phase analyte(s). The resulting electrode offers an effectively large surface area for capture and Faradic signals, but with reduced capacitance and therefore reducing background signal. For example, in some aspects, background signal may be reduced by as much as three orders of magnitude.

In some embodiments, an electrode having a plurality of discrete conductive domains may be prepared by first preparing a porous polymer electrode, as described above, and then filling the pores in the porous electrode assembly with a non-porous and non-conductive material. In one aspect, the pores can be filled with a low viscosity two-part epoxy resin, or a latent cure adhesive, among other formulations. The plurality of conductive domains can then be freed mechanically, for example by polishing, sanding, drilling, or other shaping, to reveal conductive polymer islands within the nonconducting matrix. Such conductive islands can have diameters on the order of nanometers to micrometers.

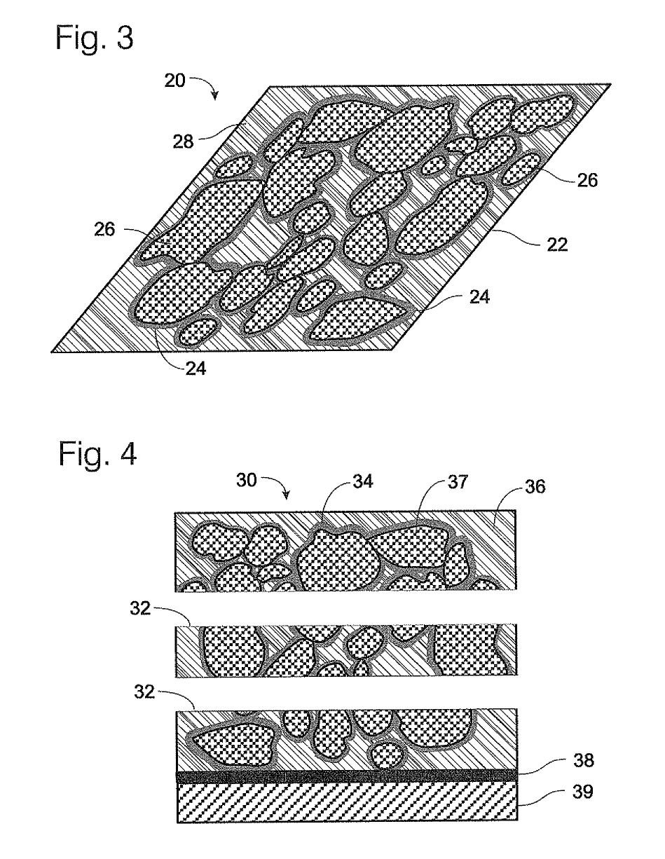

In one aspect, shown in FIG. 3, a surface of the filled electrode matrix is exposed, resulting in a planar electrode assembly 20. The exposed electrode face 22 includes conductive domains 24 separated by nonconductive material, either a nonconductive porous monolith 26, or nonconductive filler material 28. Although FIG. 3 illustrates certain relative dimensions and distributions for elements 24, 26, and 28, these dimensions and distributions are exemplary, and can be varied according to the needs of the user.

Alternatively, the advantages of having isolated conductive domains and a porous electrode matrix may be achieved by drilling or otherwise machining channels in the filled electrode matrix, to yield a porous electrode assembly 30, as shown in FIG. 4. The resulting channels 32 expose isolated domains of conductive polymer 34 in the nonconductive filler material 36 and porous monolith 38. The channels can be randomly distributed, or placed in a regular array. The resulting electrode assembly permits the flow of a sample of interest through or past the electrode, similar to the above-described porous electrode assemblies, with the additional advantage of reduced background signal.

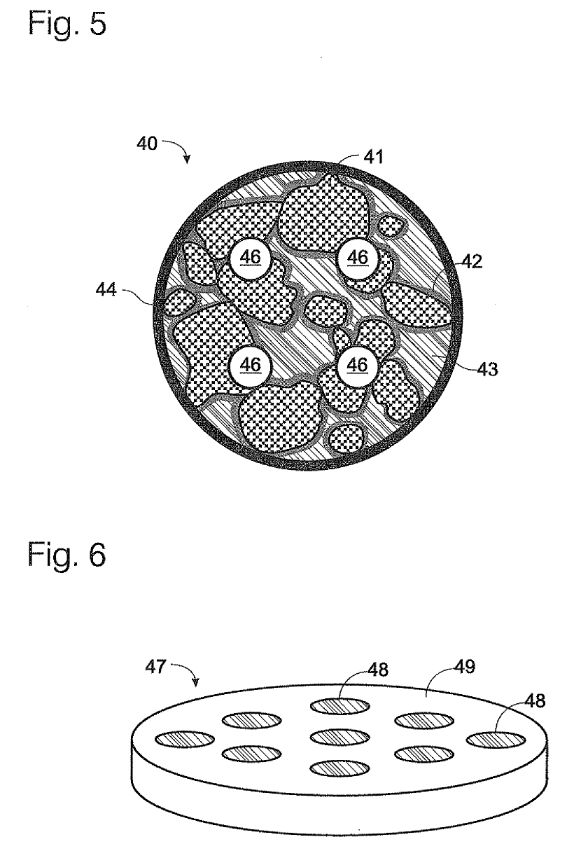

In another example, if the voids 17 of porous polymer electrode 10 of FIG. 1 were filled with a nonconductive filler material, as discussed above, and the upper and lower faces of the electrode were covered as well, a porous electrode matrix could be prepared by machining channels through the cylindrical matrix, as shown in a cross-sectional view in FIG. 5. Electrode matrix 40 includes a nonconductive porous monolith 41, coated with conductive polymer 42, and the resulting voids are filled with nonconductive filler 43. At least a portion of conductive polymer 42 is in electrical contact with a conductive layer 44. Channels 46 extend along the cylindrical axis of the electrode assembly, exposing at least a portion of the conductive polymer 42 on the inner surfaces of the channels, and permitting solution to flow through the electrode assembly. The electrode matrix can includes an array of channels having any suitable shape, number of channels, and array geometry.

As an alternative to machining, a nonconductive filler material may include a negative photoresist material. In this aspect, illumination and development of the negative resist in selected areas can also expose isolated conductive islands.

In an alternative aspect, as shown in FIG. 6, an electrode assembly 47 can include an array of conductive porous polymer electrode plugs 48, prepared within apertures or cavities formed in a nonconductive substrate 49. This type of electrode assembly may be prepared by polymerizing a porous electrode matrix as described above, within an appropriate cavity or hole in the nonconductive substrate. Electrode assembly 47 can also incorporate a conductive material in electrical connection with the porous polymer electrode plugs (not shown), for example including copper, gold, or other sufficiently inert and conductive material.

### EXEMPLARY APPLICATIONS

The porous polymer electrode assemblies described herein possess a variety of advantageous properties in electrochemical applications, including but not limited to applications in potentiometry, voltammetry, polarization, and conductimetry. In particular, the irregular and customizable topography of the electrode surface permits the researcher to investigate a variety of bioelectronic phenomena. Additionally, the surface of the porous polymer electrode can be readily customized by the selection of an appropriate monomer precursor, or by chemical modification of the surface, as is readily understood in the art.

The porous polymer electrodes can facilitate detection, quantification, immobilization, characterization, and/or purification of an analyte. The porous polymer electrodes can be utilized in vivo or in vitro. Typically, the porous polymer electrodes are useful in a method that includes contacting the electrode with the analyte of interest, and applying an electrical potential to the electrode.

Where the porous polymer electrode is utilized in combination with a selected analyte, the analyte is typically a charged species, or can be oxidized or reduced to generate a charged species. By varying the potential of the porous polymer electrode, the charged analyte species may be captured and/or concentrated and/or released. Typically, the porosity of the electrode matrix is selected to complement and spatially interact with the desired charged analyte. That is, the cavities present on the electrode surface are appropriately sized to accommodate the charged analyte. Preferably, the electrode topography is selected so that the charged analyte interacts with the electrode with some selectivity. The porous polymer electrode can therefore facilitate the capture of the desired analyte, independent of the diffusion direction, and can offer improved detection sensitivities.

Any analyte with an appropriate charge, size and shape can be an appropriate analyte for the disclosed electrodes, including analytes that are modified to include an electrochemically active tag that is either covalently or noncovalently associated with the analyte. Typically the analyte is a biomolecule. The biomolecule may be positively or negatively charged, and can include, for example, polypeptides, carbohydrates, and nucleic acid polymers.

With particular respect to analytes that are nucleic acid polymers, the nucleic acid polymer can be present as nucleic acid fragments, oligonucleotides, or larger nucleic acid polymers with secondary or tertiary structure. For example, the nucleic acid fragment can contain single-, double-, and/or triple-stranded structures. The nucleic acid may be a small fragment, or can optionally contain at least 8 bases or base pairs. The analyte can be a nucleic acid polymer that is RNA or DNA, or a mixture or a hybrid thereof. Any DNA is optionally single-, double-, triple-, or quadruple-stranded DNA; any RNA is optionally single stranded (“ss”) or double stranded (“ds”). The nucleic acid polymer can be a natural polymer (biological in origin) or a synthetic polymer (modified or prepared artificially).

Where the nucleic acid polymer includes modified nucleotide bases, the bases can include, without limitation, 4-acetylcytidine, 5-(carboxyhydroxymethyl)uridine, 2′-O-methylcytidine, 5-carboxymethylaminomethyl-2-thiouridine, 5-carboxymethylaminomethyluridine, dihydrouridine, 2′-O-methylpseudouridine, beta-D-galactosylqueuosine, 2′-O-methylguanosine, inosine, N6-isopentenyladenosine, 1-methyladenosine, 1-methylpseudouridine, 1-methylguanosine, 1-methylinosine, 2,2-dimethylguanosine, 2-methyladenosine, 2-methylguanosine, 3-methylcytidine, 5-methylcytidine, N6-methyladenosine, 7-methylguanosine, 5-methylaminomethyluridine, 5-methoxyaminomethyl-2-thiouridine, beta-D-mannosylqueuo sine, 5-methoxycarbonylmethyl-2-thiouridine, 5-methoxycarbonylmethyluridine, 5-methoxyuridine 2-methylthio-N6-isopentenyladenosine, N-((9-beta-D-ribofuranosyl-2-methylthiopurine-6-yl)carbamoyl)threonine, N-((9-beta-D-ribofuranosylpurine-6-yl)N-methylcarbamoyl)threonine, uridine-5-oxyacetic acid-methylester, uridine-5-oxyacetic acid, wybutoxosine, pseudouridine, queuosine, 5-methyl-2-thiouridine, 2-thiocytidine, 5-methyl-2-thiouridine, 2-thiouridine 4-thiouridine, 5-methyluridine N-((9-beta-D-ribofuranosylpurine-6-yl)-carbamoyl)threonine, 2′-O-methyl-5-methyluridine, 2′-O-methyluridine, wybutosine, 3-(3-amino-3-carboxy-propyl)uridine, and (acp3)u.

The nucleic acid polymer analyte is optionally present in a condensed phase, such as a chromosome. The nucleic acid polymer optionally contains one or more modified bases or links or contains labels that are non-covalently or covalently attached. For example, the modified base can be a naturally occurring modified base or a synthetically altered base. The nucleic acid polymer can also be, or can include, peptide nucleic acids such as N-(2-aminoethyl)glycine units. The nucleic acid polymer can be modified by a reactive functional group, or be substituted by a conjugated substance. In one aspect, the nucleic acid polymer is modified by that association of an electrochemically active tag for electrochemical detection.

The analyte solution can be, or can be derived from, a biological sample that is prepared from a blood sample, a urine sample, a swipe, or a smear, among others. Alternatively, the sample may be an environmental sample that is prepared from an air sample, a water sample, or a soil sample, among others. The analyte solution can be obtained by extraction from a biological structure (e.g. from lysed cells, tissues, organisms or organelles). The sample typically is aqueous but can contain biologically compatible organic solvents, buffering agents, inorganic salts, and/or other components known in the art for assay solutions.

The analyte of interest is typically present in an aqueous, mostly aqueous, or aqueous-miscible solution prepared according to methods generally known in the art. Any method of bringing the analyte solution into contact with the porous polymer electrode is generally an acceptable method of bringing the analyte into contact with the electrode. In one aspect, the electrode is immersed in the analyte solution. In another aspect, the analyte solution is applied to the electrode. Where the electrode is incorporated in an apparatus or device, the apparatus or device can include suitable fluidics for contacting or otherwise preparing the analyte solution. A chromatographic column can be placed up stream from the porous polymer electrode, where the chromatographic column can be configured to perform one or more of filtration, separation, isolation, and pre-capture/release of biomolecules or cells.

Alternatively, or in addition, the porous polymer electrode can perform the above-mentioned functions. The porous polymer electrode may be incorporated into an apparatus or device as a portion of a microplate, a PCR plate, or a silicon chip. In one aspect, the porous polymer electrode is incorporated into a device, such that the analyte solution flows through the porous matrix of the porous polymer electrode, for example a cylindrical electrode assembly, as shown in FIG. 1. Alternatively, the porous polymer electrode is adapted for immersion in an analyte solution (i.e., a ‘dip stick’), for example a planar electrode assembly, for example as shown in FIG. 2.

The porous polymer electrode assemblies described herein possess a variety of advantageous properties in electrochemical applications, including but not limited to applications in potentiometry, voltammetry, polarography, and conductimetry. In particular, the irregular and customizable topography of the electrode surface permits the researcher to investigate a variety of bioelectronic phenomena. Additionally, the surface of the porous polymer electrode can be readily customized by the selection of an appropriate monomer precursor, or by chemical modification of the surface, as is readily understood in the art.

The porous polymer electrodes can facilitate detection, quantitation, immobilization, characterization, and/or purification of an analyte. The porous polymer electrodes can be utilized in vivo or in vitro. Typically, the porous polymer electrodes are useful in a method that includes contacting the electrode with the analyte of interest, and applying an electrical potential to the electrode. The porous polymer electrodes described herein are particularly well suited for incorporation into microfluidic devices.

The step of detecting the analyte typically comprises any method of electrochemically detecting the presence of the analyte at the electrode. Typically, a potential is applied to the electrode surface, or the applied potential is varied, and a resulting current is determined. Alternatively, the potential can be held at a selected value, and a change in current is determined over time, or a constant current can be applied and the resultant voltage determined. The presence of the analyte may be qualitatively detected, or the amount of analyte can be quantitatively determined, typically by comparison with a standard, such as a known amount of the same or similar analyte. Detection and quantitation can be enhanced by the presence of an electrochemical label that is either covalently or noncovalently associated with the analyte.

The correlation generally can be performed by comparing the presence and/or magnitude of the electrochemical response to another response (e.g., derived from a similar measurement of the same sample at a different time and/or another sample at any time) and/or a calibration standard (e.g., derived from a calibration curve, a calculation of an expected response, and/or an electrochemically active reference material).

The high surface area of the disclosed porous polymer electrode may improve analyte detection sensitivity. Particularly where the analyte is a charged analyte, and an appropriate potential is applied to the electrode to capture the analyte. In one aspect, the porous polymer electrode can be used to capture and/or concentrate a charged analyte by electrostatically attracting the analyte to the electrode surface. By capturing the analyte from a flowing sample, for example, the sample can be depleted of analyte.

In one aspect of the invention, an appropriate potential may be applied to the electrode to capture and/or concentrate an analyte, such that the analyte is retained at the electrode even after the applied potential is removed. In this aspect, the captures analyte may be released by application of a potential of an opposite polarity.

In another aspect of the invention, an appropriate potential may be applied to the electrode to capture and/or concentrate an analyte, and where the applied potential is removed the captured analyte may be released into solution for collection or further characterization. This is a particularly advantageous application where the analyte is a nucleic acid or nucleic acid fragment.

For example, the charged analyte may be a nucleic acid polymer exhibiting an overall negative charge. By applying a positive charge to the porous polymer electrode, and by selecting an electrode having pores and surface features complementary to the nucleic acid polymer of interest, the nucleic acid polymers can be captured and concentrated at the electrode surface. In one aspect, the porous polymer electrode can be switched between a positively oxidized state and a neutral reduced state, and this reversibility is used to capture and release negatively charged nucleic acid fragments.

In particular, the porous polymer electrode can be used to detect and/or quantify nucleic acid fragments resulting from nucleic acid amplification. Where the analyte is the product or byproduct of a nucleic acid amplification process, the amplification process may include PCR (Polymerase Chain Reaction), OLA (Oligonucleotide Ligation Assay), isothermal methods such as RPA (Random Priming Amplification), HAD, NASBA (Nucleic Acid Sequence Based Amplification), LAMP (Loop-Mediated Isothermal Amplification), EXPAR (Exponential Amplification Reaction), or SDA (Strand Displacement Amplification), among others.

Alternatively, the nucleic acid or nucleic acid fragment may be a naturally occurring nucleic acid. Naturally occurring nucleic acids may be derived from a biological sample that is prepared from a blood sample, a urine sample, a swipe, or a smear, among others. The nucleic acid can be obtained by extraction from a biological structure (e.g. from lysed cells, tissues, organisms or organelles) such as living or dead cell, or in plasma or cell culture supernates. Alternatively, the nucleic acid may be derived from an environmental sample that is prepared from an air sample, a water sample, or a soil sample, among others.

Background noise in electrochemical systems come from inherent background currents in the measurement systems and capacitive charging currents. As these currents can be small, a better signal-to-noise ratio and sensitivity can be achieved with the electrochemical device than in devices utilizing other detection methods. Further, as electrochemical methods typically use small currents and voltages devices incorporating the porous polymer electrode typically do not require large, expensive, and heavy power supplies. This is an advantage over devices that require light sources for optical detection methods, as an electrochemical-based device typically does not require optical components such as light sources, mirrors, filters, detectors, support mechanics, or movement mechanics. Electrochemical-based devices therefore lend themselves to use in portable and/or handheld devices.

Such devices typically include the porous polymer electrode assembly, a controller configured to control the electrical potential applied at the electrode, and a sample holder and/or suitable fluidics for preparing the sample solution.

### Example 1

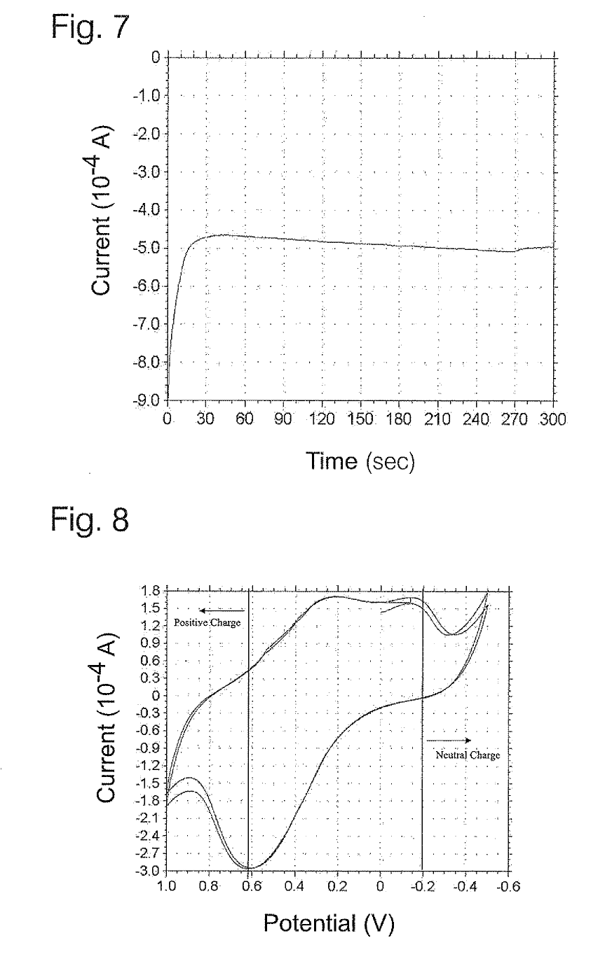

A portion of reticulated vitreous carbon (RVC) foam (average pore size about 60 μm, 12-15% density, ERG Materials and Aerospace Corp., Oakland, Calif.), roughly 3 mm×5 mm×15 mm, was cleaned by rinsing in acetone and dried under nitrogen. Electrical contact to the foam was achieved using an alligator clip. The RVC electrode was dipped into a stirred solution of 1:3 acetonitrile:deionized water containing 35 mM 3-methoxythiophene and 10 mM sodium perchlorate. The area of the RVC exposed to the solution was roughly 3 mm×5 mm×8 mm. Electropolymerization of the methoxythiophene proceeded at 1.4 V vs. Ag/AgCl for 300 sec using a platinum foil counter electrode. This activation process is shown in the plot of FIG. 7. After polymerization, the electrode was removed from the solution, rinsed with water and placed back into a solution of 10 mM sodium perchlorate. Cyclic voltammetry (20 mV/s) was then run to switch the charge state of the conductive polymer coating between positive and neutral as shown in FIG. 8.

### Example 2

Acrylation of a glass microscope slide: The slide is sonicated in a 1% SDS solution for 15 minutes, and then rinsed with DI water and dried at 110° C. The cleaned slide is then sonicated in Piranha solution for 60 minutes, rinsed with plenty of DI water, and dried at 110° C. for 10 minutes. To 120 mL of methanol is added 40 μl of 1.0 M acetic acid, resulting in a pH of 4.5-5.0. To the acidified methanol is added 3.0 mL of (3-acryloxypropyl)methyldimethoxysilane, with stirring, at ambient temperature for 10 minutes. The Piranha-treated glass slides are immersed in the silylation agent for 10 minutes, then removed, dipped into acetone briefly, and allowed to stand under a glass evaporation dish at ambient temperature for 16 hours prior to use.

### Example 3

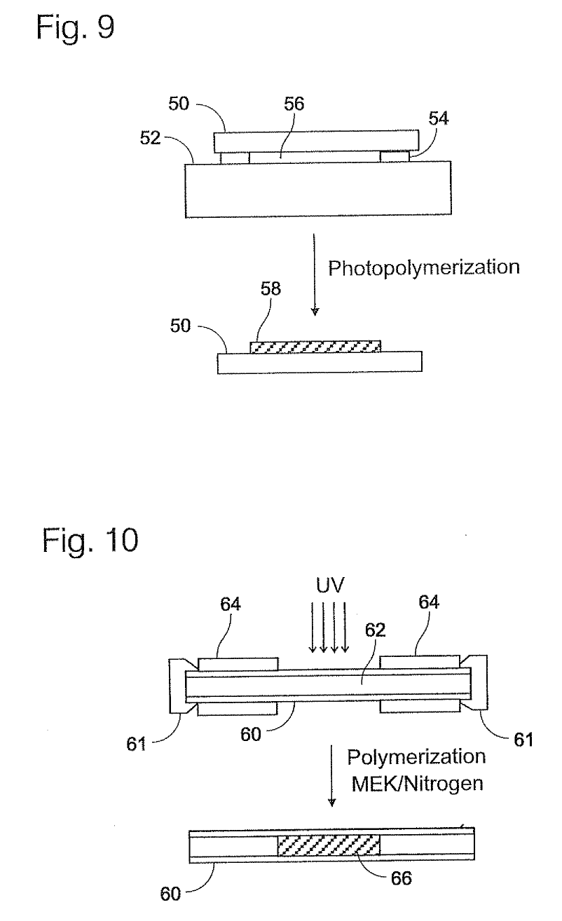

Preparation of a porous polymer monolith based on acrylic acid: As shown schematically in FIG. 9, a sandwich assembly is fabricated by placing a glass slide 50 with an acrylated surface facing the polished surface of a PFTE block 52 (See FIG. 9). A 10-100 μm thick gasket 54, rectangular in shape and made of pressure sensitive adhesive tape, is used to separate and define the space between the glass slide and the PTFE block.

A pre-polymer solution is prepared by mixing 0.64 g (8.60 mmol) of acrylic acid, 2.63 g (20.0 mmol) of butyl acrylate, 1.71 g (9.96 mmol) of ethylene glycol diacrylate, 0.096 g (0.52 mmol) of benzophenone, and 0.094 g (0.47 mmol) of ethyl 4-(dimethylamino)benzoate at ambient temperature. To a 2 mL aliquot of the pre-polymer solution, is added 2 mL of pentadecane (a porogen) to give a water-clear solution. Using a syringe, an aliquot of 20-100 μL of the water-clear solution 56 is introduced into the space between the acrylated glass slide and the PTFE block.

Photopolymerization of the pre-polymer solution is initiated by placing the assembly, with the glass slide facing up, 6 inches under a 150 Watt UV lamp (Spectroline® BIB-150P UV Lamp, Spectronics Corp., Westbury, N.Y.) for 2-10 minutes. After the photopolymerization, the PTFE block is lifted and the gasket removed. The resulting chemically-bonded polymer film is rinsed with methyl ethyl ketone and dried using a stream of nitrogen gas, to yield a porous polymer film 58

### Example 4

Preparation of porous polymer monolith inside a glass capillary: The inner surface of a glass capillary 60, 1.5 mm I.D. and 10 cm in length, is surface-acrylated according to the general procedure described above. A monomer solution is prepared by dissolving 3.82 g (53.02 mmol) of acrylic acid, 1.0 g (6.50 mmol) of N,N-methylenebisacrylamide, 0.42 g (4.20 mmol) of methyl methacrylate, 0.147 g (0.808 mmol) of benzophenone, and 0.16 g (0.82 mmol) of ethyl 4-(dimethylamino)benzoate in 4.02 g (55.75 mmol) of methyl ethyl ketone (a porogen). As shown schematically in FIG. 10, the ends of the capillary tube are sealed using rubber septa 61. Using a syringe, an aliquot of this monomer solution 62 is used to fill the acrylate-treated glass capillary as showed in the FIG. 2 below. Black adhesive tape was use as masking 64, exposing the central part of the capillary to UV light for 1-10 minutes. At the end of the photopolymerization, fresh methyl ethyl ketone is injected into capillary to flush away any un-reacted monomers. Residual solvent is evaporated by passing a stream of nitrogen through to capillary, resulting in a porous polymer plug 66 in the middle of the capillary.

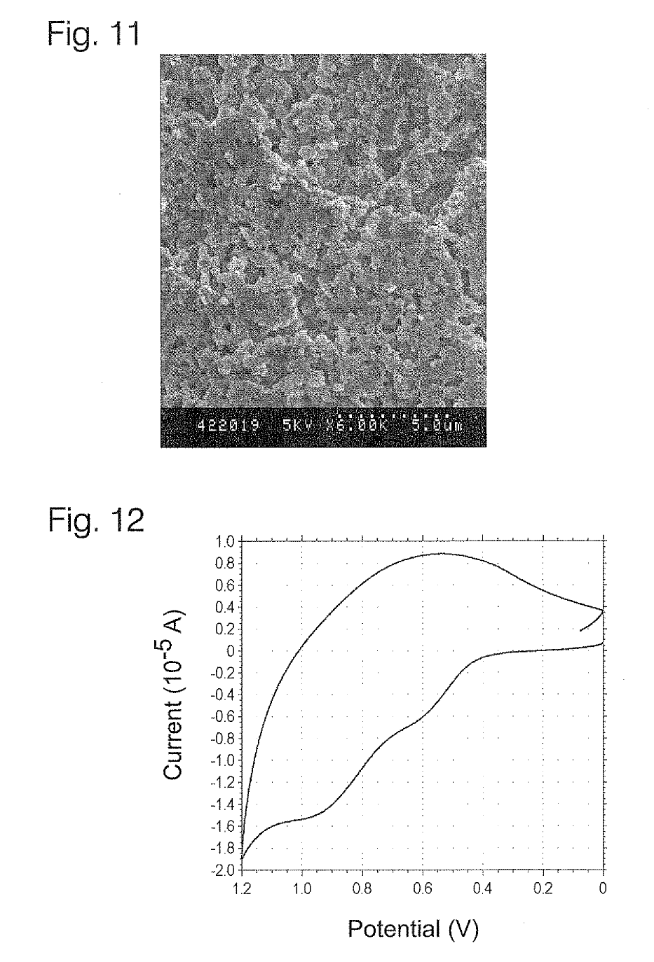

A morphology for a typical porous monolith prepared according to this general protocol is showed in FIG. 11. For those with ordinary skill in the art can tailor the porosity and pore size by varying the composition and concentration of each ingredient in the monomer solution.

### Example 5

General procedure for the preparation and characterization of a planar vitreous carbon electrode coated with poly(3-butylthiophene-2,5-diyl): To 1.0 mL of nitrobenzene in a polypropylene micro-centrifuge tube, 2.3 mg of regioregular poly(3-butylthiophene-2,5-diyl) (Aldrich Chemical) is added. The mixture is sonicated for 10 minutes, vortexed for 5 minutes, and tumbled for 16 hours to give a dark brown solution. The solution is filtered using a polypropylene syringe and a 0.2μ a PTFE filter membrane (Pall Gelman Laboratory, Ann Arbor, Mich.). A droplet of the filtered solution, 1 μL, was place on the cleaned and polished surface of a vitreous carbon disk electrode, 3 mm in diameter (Cypress Systems, Chelmsford, Mass.). The solvent is evaporated in a convection oven at 50° C. for 3 hours.

An Electrochemical Workstation (CH Instruments, Austin, Tex.) equipped with a platinum wire counter electrode and a silver/silver chloride reference electrode (Cypress Systems, Chelmsford, Mass.) is used for cyclic voltammetry using the resulting modified electrode. The electrolyte used is a 0.1 M aqueous solution of sodium perchlorate containing 0.1 wt % of Tween® 20 (Aldrich Chemical, Milwaukee, Wis.). The typical scanning rate is 20-50 mV per second. A typical cyclic voltammogram having two oxidation peaks at about 0.60 and 0.95 volt is shown in FIG. 12.

### Example 6

General procedure for the preparation and characterization of reticulated vitreous carbon electrode coated with poly(3-butylthiophene-2,5-diyl): A porous vitreous carbon electrode is fabricated by joining a cylindrical plug of reticulated vitreous carbon, RVC (obtained from ERG, Oakland, Calif.), 3 mm in diameter and 5 mm in length to the sharpened tip of a glassy carbon rod, 3 mm in diameter and 7 cm in length using a silver conductive epoxy (EPO-TEK® E2101, Epoxy Technology, Billerica, Mass.). The porous electrode is dipped briefly into a filtered solution of poly(3-butylthiophene-2,5-diyl, prepared as described above, to a depth of 3 mm above the RVC plug. The electrode is removed, excess of solution is shaken off, and the electrode is dried in a convection oven for 16 hours prior to use. A morphology for a typical electrode prepared according to this general protocol is shown in FIG. 13. Cyclic voltammograms are recorded using the electrode in the same set-up and under the same experimental conditions as described previously (See Example 5), as shown in FIG. 14.

Although the present invention has been shown and described with reference to the foregoing operational principles and preferred embodiments, it will be apparent to those skilled in the art that various changes in form and detail can be made without departing from the spirit and scope of the invention. The present invention is intended to embrace all such alternatives, modifications and variances that fall within the scope of the appended claims.

We claim:

1. A porous polymer electrode assembly, comprising:
a porous monolith;
a conductive polymer applied to at least a portion of the porous monolith, so that the surface of the conductive polymer defines a porous topography; and
a conductive material in electrical contact with at least a portion of the conductive polymer adapted to provide an electrical connection to a potential source.

2. The electrode assembly of claim 1, wherein the conductive material includes a conductive metal.

3. The electrode assembly of claim 1, further comprising a substrate adapted to support the porous monolith and conductive polymer.

4. The electrode assembly of claim 1, wherein the porous monolith includes a poly(acrylic acid) polymer or copolymer.

5. The electrode assembly of claim 4, wherein the porous monolith is prepared using phase separation and precipitation techniques.

6. The electrode assembly of claim 4, wherein the monolith is prepared by sintering polymeric microparticles.

7. The electrode assembly of claim 1, wherein the porous monolith is a porous carbon monolith.

8. The electrode assembly of claim 1, wherein the porous monolith has a macroporous topography.

9. The electrode assembly of claim 1, wherein the porous monolith includes pores having diameters of about 2 μm to about 100 μm.

10. The electrode assembly of claim 1, wherein the conductive polymer includes conductive polythiophene polymers or copolymers.

11. The electrode assembly of claim 1, wherein the applied conductive polymer has a thickness of about 10 Å to about 5 μm.

12. The electrode assembly of claim 1, wherein the applied conductive polymer has a thickness of about 5 nm to about 1000 nm.

13. A porous polymer electrode assembly, comprising:
a macroporous monolith;
a conductive polymer applied to at least a portion of the macroporous monolith, so that the surface of the conductive polymer defines a macroporous topography; and
a conductive material in electrical contact with at least a portion of the conductive polymer adapted to provide an electrical connection to a potential source.

14. The electrode assembly of claim 13, wherein the macroporous monolith includes pores having diameters of about 2 μm to about 100 μm.

15. A porous polymer electrode assembly, comprising:
a substrate;
a conductive layer disposed on the substrate;
a porous monolith disposed on the conductive layer; and
a conductive polymer applied to the porous monolith, so that the conductive polymer at least partially defines the pores present in the porous monolith, and so that an electrical connection is formed between the conductive layer and the conductive polymer.

16. An electrode assembly, comprising
a porous nonconductive monolith;
a nonporous and nonconductive filler material filling the pores of the porous monolith; and
a conductive polymer disposed in the pores of the monolith, and interposed between the monolith and the filler material.

17. The electrode assembly of claim 16, wherein a surface of the electrode assembly exposes a plurality of conductive domains at least partially isolated by nonconductive filler material and nonconductive monolith.

18. The electrode assembly of claim 16, wherein channels present in the assembly expose a plurality of conductive domains at least partially isolated by nonconductive filler material and monolith.

19. An electrochemical device comprising a porous polymer electrode, where the porous polymer electrode includes:
a porous monolith;
a conductive polymer applied to at least a portion of the porous monolith, so that the surface of the conductive polymer defines a porous topography; and
a conductive material in electrical contact with at least a portion of the conductive polymer adapted to provide an electrical connection to a potential source.

20. The electrochemical device of claim 19, further comprising a controller adapted to control the potential applied to the electrode assembly.

21. The electrochemical device of claim 19, further comprising fluidics for bringing a sample solution into contact with the electrode assembly.
